(19) United States
(12) Patent Application Publication
(10) Pub. No.: US 2015/0323688 A1
(43) Pub. Date: Nov. 12, 2015

(54) SEISMIC DATA PROCESSING

(71) Applicant: WESTERNGECO L.L.C., HOUSTON, TX (US)

(72) Inventors: CHENGBIN PENG, SUGAR LAND, TX (US); JUN TANG, SUGAR LAND, TX (US); MARTA WOODWARD, HOUSTON, TX (US)

(21) Appl. No.: 14/805,962

(22) Filed: Jul. 22, 2015

Related U.S. Application Data
(63) Continuation of application No. 14/153,894, filed on Jan. 13, 2014.

(51) Int. Cl. G01V 1/28; G01V 1/34

(52) U.S. Cl. CPC G01V 1/282; G01V 1/34

(57) ABSTRACT

Described herein are implementations of various technologies for a method for processing seismic data corresponding to a region of interest. The method may receive the seismic data. The method may separate the received seismic data into refraction packets and reflection packets. The method may receive a model for the region of interest. The method may update a first portion of the received model using the refraction packets with refraction traveltime tomography. The method may use the updated model to facilitate hydrocarbon exploration or production.

### CROSS-REFERENCE TO RELATED APPLICATION

This application is a continuation of co-pending U.S. patent application Ser. No. 14/153,894, filed Jan. 13, 2014, which claims the benefit of U.S. Provisional Patent Application Ser. No. 61/752,011 filed Jan. 14, 2013. Each of the aforementioned related patent applications is herein incorporated by reference.

### BACKGROUND

This section is intended to provide background information to facilitate a better understanding of various technologies described herein. As the section's title implies, this is a discussion of related art. That such art is related in no way implies that it is prior art. The related art may or may not be prior art. It should therefore be understood that the statements in this section are to be read in this light, and applicant neither concedes nor acquiesces to the position that any given reference is prior art or analogous prior art.

Seismic exploration may utilize a seismic energy source to generate acoustic signals that propagate into the earth and partially reflect off subsurface seismic reflectors (e.g., interfaces between subsurface layers). The reflected signals are recorded by sensors (e.g., receivers or geophones located in seismic units) laid out in a seismic spread covering a region of the earth's surface. The recorded signals may then be processed to yield a seismic survey.

As seismic exploration becomes increasingly complex, the importance of analyzing seismic samples increases. In areas of complex geology, seismic depth-migration projects may involve many iterations of model refinement before arriving at a final model. This refinement process is time-consuming and costly, because each iteration may include a complete remigration of the whole prestack seismic data volume, followed by interpretation of the changes in the image, and updating of the model to account for the changes.

Accordingly, there is a need for methods and computing systems that can employ more effective and accurate methods for identifying, isolating and/or processing various aspects of seismic signals or other data that is collected from a subsurface region or other multi-dimensional space.

### SUMMARY

In some implementations, a method for processing seismic data corresponding to a region of interest is provided. The method may receive the seismic data. The method may separate the received seismic data into refraction packets and reflection packets. The method may receive a model for the region of interest. The method may update a portion of the received model using the refraction packets with refraction traveltime tomography. The method may use the updated model to facilitate hydrocarbon exploration or production.

In some implementations, a method for processing seismic data corresponding to a region of interest is provided. The method may receive the seismic data. The method may decompose the received seismic data into seismic packets. The method may separate the seismic packets into refraction packets and reflection packets. The method may receive a model that describes the region of interest. The method may update a first portion of the received model using the refraction packets with refraction traveltime tomography. The method may update a second portion of the received model using the reflection packets with reflection tomography. The method may use an updated model based on the updated first portion and second portion of the received model to facilitate hydrocarbon exploration or production.

In some implementations, a method for processing seismic data corresponding to a region of interest is provided. The method may separate the data into refraction packets and reflection packets. The method may receive a model that describes the region of interest. The method may update a first portion of the received model using the refraction packets with refraction traveltime tomography. The method may update a second portion of the received model using the reflection packets with reflection tomography.

The above referenced summary section is provided to introduce a selection of concepts that are further described below in the detailed description section. The summary is not intended to identify features of the claimed subject matter, nor is it intended to be used to limit the scope of the claimed subject matter. Furthermore, the claimed subject matter is not limited to implementations that solve any or most disadvantages noted in any part of this disclosure. Indeed, the systems, methods, processing procedures, techniques and workflows disclosed herein may complement or replace conventional methods for identifying, isolating, and/or processing various aspects of seismic signals or other data that is collected from a subsurface region or other multi-dimensional space.

### BRIEF DESCRIPTION OF THE DRAWINGS

Implementations of various technologies will hereafter be described with reference to the accompanying drawings. It should be understood, however, that the accompanying drawings illustrate various implementations described herein and are not meant to limit the scope of various technologies described herein.

FIG. 1 illustrates a diagrammatic view of marine seismic surveying in accordance with various implementations described herein.

FIG. 2 illustrates a flow diagram of a method for processing seismic data in accordance with various implementations described herein.

FIG. 3 illustrates ray tracing in accordance with various implementations described herein.

FIG. 4 illustrates a computer system in which the various technologies and techniques described herein may be incorporated and practiced.

### DETAILED DESCRIPTION

The discussion below is directed to certain specific implementations. It is to be understood that the discussion below is for the purpose of enabling a person with ordinary skill in the art to make and use any subject matter defined now or later by the patent “claims” found in any issued patent herein.

Reference will now be made in detail to various implementations, examples of which are illustrated in the accompanying drawings and figures. In the following detailed description, numerous specific details are set forth in order to provide a thorough understanding of the claimed invention. However, it will be apparent to one of ordinary skill in the art that the claimed invention may be practiced without these specific details. In other instances, well known methods, procedures, components, circuits, and networks have not been described in detail so as not to unnecessarily obscure aspects of the claimed invention.

It will also be understood that, although the terms first, second, etc. may be used herein to describe various elements, these elements should not be limited by these terms. These terms are used to distinguish one element from another. For example, a first object or block could be termed a second object or block, and, similarly, a second object or block could be termed a first object or block, without departing from the scope of the invention. The first object or block, and the second object or block, are both objects or blocks, respectively, but they are not to be considered the same object or block.

The terminology used in the description herein is for the purpose of describing particular implementations and is not intended to limit the claimed invention. As used herein, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, blocks, operations, elements, and/or components, but do not preclude the presence or addition of one or more other features, integers, blocks, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

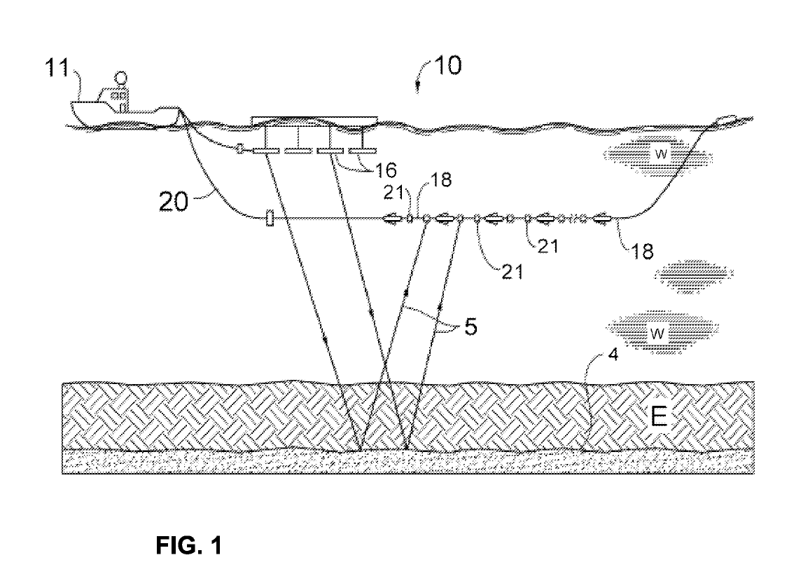

FIG. 1 illustrates a diagrammatic view of marine seismic surveying 10 in connection with implementations of various techniques described herein. A marine seismic acquisition system 10 may include a vessel 11 carrying control components and towing a plurality of seismic sources 16 and a plurality of streamers 18 equipped with seismic receivers 21. The seismic sources 16 may include a single type of source, or different types. The sources may use any type of seismic generator, such as air guns, water guns, steam injection sources, controllable seismic sources, explosive sources such as dynamite or gas injection followed by detonation and the like. The streamers 18 may be towed by means of their respective lead-ins 20, which may be made from high strength steel or fiber-reinforced cables that convey electrical power, control and data signals between the vessel 11 and the streamers 18. An individual streamer may include a plurality of seismic receivers 21 that may be distributed at spaced intervals along the streamer's length. The seismic receivers 21 may include hydrophone sensors as well as multi-component sensor devices, such as accelerometers. Further, the streamers 18 may include a plurality of inline streamer steering devices (SSDs), also known as “birds.” The SSDs may be distributed at appropriate intervals along the streamers 18 for controlling the streamers' depth and lateral movement. A single survey vessel may tow a single receiver array along individual sail lines, or a plurality of survey vessels may tow a plurality of receiver arrays along a corresponding plurality of the sail lines.

During acquisition, the seismic sources 16 and the seismic streamers 18 may be deployed from the vessel 11 and towed slowly to traverse a region of interest. The seismic sources 16 may be periodically activated to emit seismic energy in the form of an acoustic or pressure wave through the water. The sources 16 may be activated individually or substantially simultaneously with other sources. The acoustic wave may result in one or more wavefields that travel coherently into the earth E underlying the water W. As the wavefields strike interfaces 4 between earth formations, or strata, they may be reflected back through the earth E and water W along paths 5 to the various receivers 21 where the wavefields (e.g., pressure waves in the case of air gun sources) may be converted to electrical signals, digitized and transmitted to the integrated computer-based seismic navigation, source controller, and recording system in the vessel 11 via the streamers 18 and lead-ins 20. Through analysis of these detected signals, it may be possible to determine the shape, position and lithology of the sub-sea formations, including those formations that may include hydrocarbon deposits.

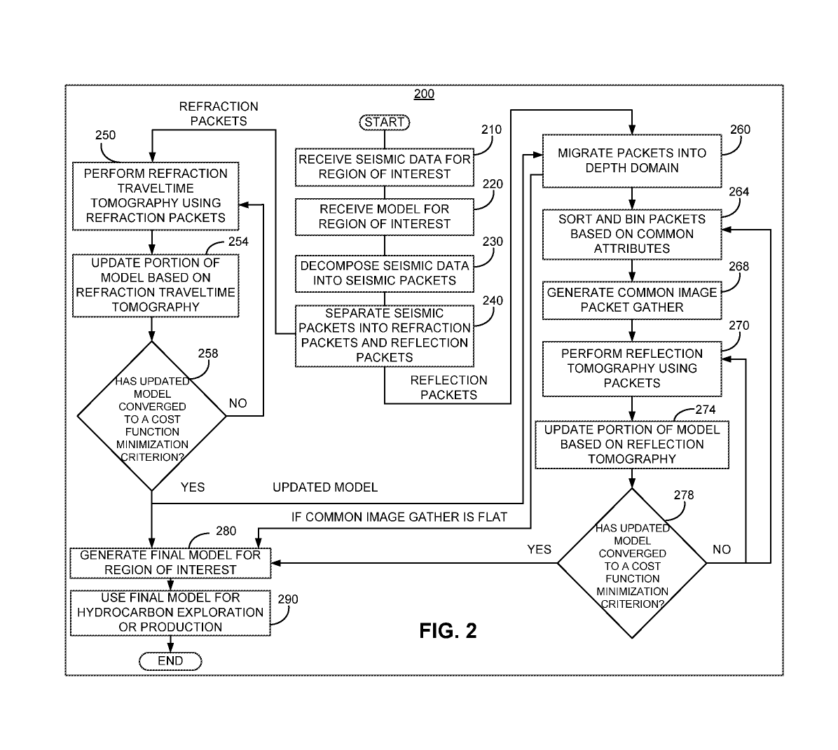

FIG. 2 illustrates a flow diagram of a method for processing seismic data in accordance with various implementations described herein. It should be understood that while the operational flow diagram indicates a particular order of execution of the operations, in other implementations, the operations might be executed in a different order. Further, in some implementations, additional operations or blocks may be added to the method. Likewise, some operations or blocks may be omitted.

At block 210, seismic data are received for a region of interest (i.e., “the received seismic data”). For instance, the seismic data may include a seismic volume obtained from a seismic survey. In one implementation, the seismic data may be from a common shot gather. The region of interest may include an area of the subsurface in the earth that may be of particular interest, such as for hydrocarbon production.

At block 220, an initial model may be received for the region of interest (i.e., “the received model”). For instance, the initial model may be a velocity model or an anisotropic model that describes the region of interest. One such initial model may be obtained by using intercept times and local slopes based on a Herglotz-Wiechert inversion of the received seismic data from block 210.

At block 230, the received seismic data are decomposed into seismic packets. Regarding decomposition, a seismic dataset may be viewed as a superposition of individual seismic attributes. As such, a seismic packet may include data regarding these seismic attributes. When a dataset is decomposed into a finite number of seismic packets, the seismic packets may have the capability to recombine and approximately produce the original dataset. In this regard, the decomposed seismic packets at block 230 may be recombined to produce, approximately, the received seismic data at block 210.

In regard to the seismic attributes, a seismic packet may include beam components as well as direct and derived attributes of the received seismic data. Direct attributes may include seismic amplitudes, spatial locations of a beam center (e.g., x, y and z locations), acquisition source-receiver offsets, acquisition azimuths and coherency for seismic traces. Derived attributes may include the reflection angle, the reflection azimuth, a source-side time dip, a receiver-side time dip, a wavelet stretch and a beam spread of a seismic wave.

Further, the seismic packets may be locally coherent wave packets with compact support in both space and time, and expressed using the following equation:

$$D ( s , g , t ) = {\sum }_{i} {δ}_{i} ( s , g , t \vert {g}_{i} , {t}_{i} , {p}_{ri} ) \qquad Equation 1$$

where D(s,g,t) is the received seismic data, δᵢ(s,g,t|gᵢ,tᵢ,pᵣᵢ) is an i^{th} seismic packet at center time tᵢ, center source sᵢ, and center receiver gᵢ with a receiver-side time dip pry (also called the time slope vector). The receiver-side time dip pᵣᵢ may describe the direction that a wave approaches receiver gᵢ. As such, the receiver-side time dip pᵣᵢ may include x-component pₓ or y-component p_{y} of the approaching wave. By virtue of reciprocity theorem one may also write Equation 1 in terms of the source-side time dip if the received seismic data is in common receiver gather order.

In another implementation, the seismic packets may be described with respect to the source wavelet and expressed using the following equation:

δᵢ(s,g,t|gᵢ,tᵢ,pᵣᵢ)=wᵢ(t−tᵢ−pᵣᵢ·(g−gᵢ))W(g−gᵢ) Equation 2

where wᵢ is the source wavelet for the i^{th} seismic packet, while W denotes a Gaussian weighting function for making the i^{th} seismic packet compact within a local zone.

At block 240, the seismic packets from block 230 may be separated into refraction packets and reflection packets. For instance, refraction packets may be separated out from the seismic packets and sent to block 250. Reflection packets may be separated out of the seismic packets and sent to block 260.

Both refraction packets and reflections packets may include the same type of information as the seismic packets from block 230. However, different types of packets may refer to different types of pressure waves that pass through the earth's subsurface. The refraction packets may describe information regarding a refractive wave from a source to a receiver, where the path of the wave is not changed by the wave's reflection at an impedance interface between the source and the receiver. As such, refractive waves may include early-arrivals (e.g., diving waves, head waves or wide-angle reflections) that may undergo continuous refractions throughout the subsurface. Refracted waves may be strong and coherent while receiving little influence by multiples, shear or converted waves, which may make them very suitable for velocity analysis. In another respect, refracted waves may be associated with long wave paths and large apertures, which may be used to obtain an initial model of long wavelength.

On the other hand, the reflection packets may describe information regarding a reflected wave that travels from a source to a receiver, and where the reflecting wave's path is changed by one or more reflections at impedance interfaces between the source and the receiver. During a reflection, the reflected wave may exit an interface at the same angle as the angle of incidence, which may alter the reflected wave's path through the region of interest.

Several methods may be used to separate the seismic packets produced at block 230 into refraction packets and reflection packets. In one implementation, refraction packets or reflection packets may be separated from the seismic packets using source to receiver traveltimes. For instance, a time window may be used to isolate the refraction packets from the rest of the seismic packets. As such, the time window may filter out seismic packets that arrive inside a predetermined time. The predetermined time may correspond to a designated time period when the majority of early-arrival waves have reached a corresponding receiver. The seismic packets that include acquisition times outside the designated time period may be determined to be a refraction packet, while those seismic packets with acquisition times inside the designated time period may be determined to be reflection packets or other types of data.

In another implementation, source-receiver offsets may be used in the separation process at block 240 in a similar manner to the time window described above. For instance, a distance window may be used where seismic packets that include source-receiver offsets outside the distance window may be considered refraction packets and those inside the distance window may be considered reflection packets.

At block 250, the refraction packets may be used to perform refraction traveltime tomography. For instance, using a refraction packet for a source located at s and receiver located at g, a total observed traveltime t^{obs}, and a receiver-side time dip pᵣᵢ (i.e., for packet i, a time dip in the x-direction and/or y-direction), the modeled traveltime t^{cal} may be estimated by modeling or backprojecting a ray from the receiver at g using the receiver-side time dip pry and searching for one point X along a corresponding ray path back to the source at s.

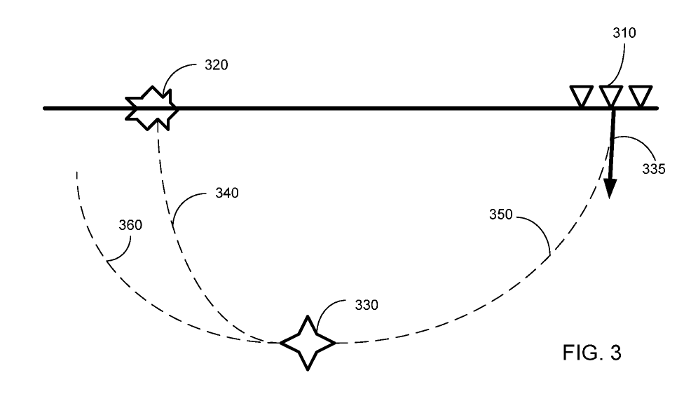

FIG. 3 illustrates an example of ray tracing that may be used in block 250. In an early-arrival traveltime tomographic algorithm, a ray path 350 between receivers 310 and point 330 may be modeled using the received model from block 220. Based on the time dip 335 recorded at receivers 310, the ray path 350 may be modeled backwards to the source 320 using the observed traveltime between the firing of the source 320 and the arrival of the seismic wave at the receivers 310. For instance, modeled ray path 360 using a calculated traveltime from the point 330 to the source 320 misses the source 320. Ray tracing may then be repeated until a ray path 340 is produced that reaches the source 320 from point 330. In one implementation, the early-arrival traveltime tomographic algorithm may take into account early-arrivals in addition to the first break arrivals, which may allow for no explicit selecting of first break arrivals. This may be advantageous as compared to known diving wave tomography.

Returning to block 250, the refraction packets may be used to model a ray path from a source to a receiver. Searching for the one point X may be performed so that a seismic ray may take a minimum amount of traveltime from the source s, through an image point X (e.g., the point 330 in FIG. 3), and to the receiver g according to Fermat's principle expressed by the following equation being stationary:

t_{cal}=t_{gx}+tₛₓ Equation 3

where t^{cal} is the total modeled traveltime, tₛₓ is the traveltime from the source to image point X, and t_{gx} is the traveltime from the receiver to the image point X. tₛₓ may be computed using a traveltime table and t_{gx} may be computed by ray tracing one ray.

At block 254, a portion of the received model is updated based on the refraction traveltime tomography from block 250. Similar to other methods of tomography, updating the portion of the received model may include solving the refraction traveltime tomography problem by iteratively minimizing a cost function minimization criterion. This update may involve internal nonlinear iterations. As such, updating the received model may be performed iteratively by calculating new values for the received model and using those new values at block 250 if the updated model has not converged to a cost function minimization criterion at block 258. Thus, the gradient field for a cost function regarding the received model's parameters may be calculated and a conjugate gradient method may be used to update the received model.

A cost function minimization criterion may designate when the error in an updated model approaches a specific degree of accuracy. When the updated model converges to a cost function minimization criterion, the updated model may be determined as accurate for the region of interest. If two refraction packets are for the same event, the packets' attributes may be highly correlated. In one implementation, a cost function minimization criterion may be the difference between a forward-modeled prediction of the region of interest and the received seismic data or the data in the refractions packets from block 240. One instance of a cost function may be shown by the following equation:

$${E}_{1} ( m ) = \frac{1}{2} {\sum }_{s} {\sum }_{g} {\sum }_{i} {( {t}_{sgi}^{obs} - {t}_{sgi}^{cal} )}^{2} \qquad Equation 4$$

where t_{sgi}^{obs} and t_{sgi}^{cal} denote the observed and calculated traveltimes for the i^{th} wave arrivals for source s and receiver g, respectively. In updating a model using refraction traveltime tomography, the model's values with respect to one or more modeled ray paths may be adjusted in order to reduce E₁(m). Furthermore, the first order perturbation of the cost function shown in Equation 4 may be provided by the following equation:

$$δ {E}_{1} ( m ) = - {\sum }_{s} {\sum }_{g} {\sum }_{i} ( {t}_{sgi}^{obs} - {t}_{sgi}^{cal} ) δ {t}_{sgi}^{cal} \qquad Equation 5$$

where δt_{sgi}^{cal} denotes the perturbation of the total traveltime for the calculated early-arrival ray path for the refraction packet. The model parameter perturbation δm may be determined using the following equation:

$$δ {t}_{sgi}^{cal} = {\sum }_{j} \frac{\partial {t}_{sgi}^{cal}}{\partial {m}_{j}} δ {m}_{j} \qquad Equation 6$$

where

$$\frac{\partial {t}_{sgi}^{cal}}{\partial {m}_{j}}$$

denotes the traveltime changes corresponding to the change of the model parameter m at subsurface grid node j along the calculated early-arrival ray path.

At block 258, it is determined whether the updated model has converged to a corresponding cost function minimization criterion. If the updated model from block 254 has not converged to a cost function minimization criterion, the process may return to block 250 to repeat refraction traveltime tomography using the updated model, an internal nonlinear iteration. If the updated model has converged to a corresponding cost function minimization criterion, the process may proceed to block 280 to generate a final model for the region of interest. In one implementation, the updated model may provide a shallow depth model for the region of interest. The process may also proceed to block 260 to further update the updated model using the reflection packets and reflection tomography.

Blocks 260-278 may describe several different process flows in regard to the reflection packets from block 240. For instance, in one implementation, the process flow from blocks 250-258 may be performed simultaneously with the process flow involving reflection tomography in blocks 260-278 in order to generate a final model at block 280. In another implementation, the updated model produced by blocks 250-258 may be used for performing the reflection tomography at blocks 260-278. In another implementation, one or more blocks between 260-278 may be excluded from the process.

At block 260, the reflection packets from block 240 may be migrated into the depth domain (i.e., “migrated packets”). For instance, the received seismic data at block 210 may include data in the time domain that corresponds to the acquisition time of the seismic data during a survey. Through ray tracing, seismic packets may be migrated into the depth-domain by shooting a ray from receiver position gᵢ with the receiver-side time dip pᵣᵢ, and searching for the source-side time dip such that the image point \vec{X}ᵢ=(xᵢ,yᵢ,zᵢ) satisfies a total traveltime image condition tᵢ, which may be similar to Equation 3. The total traveltime image condition may be expressed by the following equation:

t_{s\vec{X}}_{ᵢ}+t_{g}_{ᵢ}_{\vec{X}}_{ᵢ}=tᵢ, Equation 7

where t_{s\vec{X}}_{ᵢ} is the traveltime from the source to an image point \vec{X}ᵢ,t_{g}_{ᵢ}_{\vec{X}}_{ᵢ} is the traveltime from the image point to the receivers. Similar to seismic packets in the time-domain, a migrated packet may have compact support near the image point \vec{X}ᵢ. Further, a seismic packet in the depth domain Δi(\vec{X}|\vec{X}ᵢ,\vec{n}ᵢ,θᵢ,φᵢ,sᵢ,gᵢ) may be determined using the following equation:

$${Δ}_{i} ( \vec{X} \vert {\vec{X}}_{i} , {\vec{n}}_{i} , {θ}_{i} , {ϕ}_{i} , {s}_{i} , {g}_{i} ) = {w}_{i} ( {τ}_{{s}_{i} {\vec{X}}_{i} {g}_{i}} - {t}_{i} + \frac{( \vec{X} - {\vec{X}}_{i} ) \cdot {\vec{n}}_{i}}{{v}_{i}} ) {W}_{i} ( \vec{X} , {\vec{X}}_{i} , {\vec{n}}_{i} ) \qquad Equation 8$$

where τₛ_{ᵢ}_{\vec{X}}_{ᵢ}_{g}_{ᵢ} denotes the total traveltime from source sᵢ though the image point \vec{X}ᵢ and then back to the receiver gᵢ, θᵢ is the reflection angle, φᵢ is the subsurface azimuth, vᵢ represents the velocity at the packet center \vec{X}ᵢ along the normal direction \vec{n}ᵢ, and Wᵢ(\vec{X},\vec{X}ᵢ,\vec{n}ᵢ) denotes a 3D tapering function.

Once a seismic packet is migrated into the depth domain, subsurface information may be obtained regarding the migrated energy such as dips, azimuths and reflection angles, as well as associated surface information about the unmigrated data like source and receiver locations, source-side or receiver-side local time dips (e.g., dt/dsx, dt/dsy, dt/dgx, dt/dgy, dt/dhx and dt/dhy), coherencies and wavelets.

In one implementation, at block 260, the migrated packets are analyzed for whether a flat common image gather is produced. If a resulting common image gather from the migrated packets is flat, the migrated packets may proceed to block 280 for generating a final model. If the common image gather is not flat, the process may proceed to block 264, an internal nonlinear iteration.

At block 264, the migrated packets are sorted and binned into different groups based on common attributes. For instance, the migrated packets may be sorted according to offsets, reflection angles, or other packet attributes. Then, the sorted migrated packets may be binned into different groups such that binned packets are for the same event (e.g., for the same fault or the same reflection at a reflection interface). For instance, migrated packets may be binned into a group based on the following criteria:

$${t}_{{h}_{1}} - {t}_{{h}_{2}} \approx \frac{d t}{d h} ( {h}_{1} - {h}_{2} ) \qquad Equation 9$$

where tₕ_{₁} and tₕ_{₂} denote the traveltimes for two migrated packets for the same event with offsets h₁ and h₂, respectively. The source wavelets for migrated packets in the same group may be highly correlated, which may serve as a grouping criteria to avoid cycle skipping. Migrated packets within a group may also be selected such that the packets within a group are located within a predetermined distance from the corresponding event. User input may also be used to select or mask certain types of packets from the sorting or binning process, such as those packets associated with faults, steep events or a salt over-hang.

At block 268, a common image packet gather may be generated from the migrated packets. In some implementations, a common image packet gather may be formed using migrated packets that contribute to the same image location (i.e., the same location in the subsurface of the region of interest). If the migrated packets are resorted according to offsets or reflection angles, and the binned packets are reconstructed from the result, then a common image offset gather or a common image angle gathers may be obtained.

In one implementation, two migrated packets that are in a common image packet gather may be represented as Δᵢ and Δⱼ. The two migrated packets may be compared in the form of a differential semblance as described by the following equation:

$${ɛ}_{ij} = - {\sum }_{x} {\sum }_{y} {\sum }_{z} {Δ}_{i} ( \vec{X} \vert {\vec{X}}_{i} , {\vec{n}}_{i} , {θ}_{i} , {ϕ}_{i} , {s}_{i} , {g}_{i} ) {Δ}_{j} ( \vec{X} \vert {\vec{X}}_{j} , {\vec{n}}_{j} , {θ}_{j} , {ϕ}_{j} , {s}_{j} , {g}_{j} ) \qquad Equation 10$$

where the summation is over a local 3D space that may be in close proximity to the two migrated packets. Equation 10 may define the correlation between the two migrated packets. When a model accurately describes the region of interest, two migrated packets for the same event may be highly correlated. As such, the differential semblance for the two migrated packets may be expressed by the following equation:

$${ɛ}_{ij} = - {\sum }_{x} {\sum }_{y} {\sum }_{z} {w}_{i} ( {τ}_{{s}_{i} {\vec{X}}_{i} {g}_{i}} - {t}_{i} + \frac{( \vec{X} - {\vec{X}}_{i} ) \cdot {n}_{i}}{{v}_{i}} ) {w}_{j} ( {τ}_{{s}_{j} {\vec{X}}_{j} {g}_{j}} - {t}_{j} + \frac{( \vec{X} - {\vec{X}}_{j} ) \cdot {\vec{n}}_{j}}{{v}_{j}} ) {W}_{i} {W}_{j} \qquad Equation 11$$

where Wᵢ and Wⱼ are 3D tapering functions for the two migrated packets.

At block 270, the migrated packets or the reflection packets from block 250 may be used to perform reflection tomography. For instance, ray tracing may be done in the depth-domain similar to the ray path modeling done in the time-domain as described in regard to FIG. 3 above.

At block 274, a portion of the received model from block 220, the updated model from block 258, or a model previously updated at block 274 may be updated based on the reflection tomography from block 270. Updating this portion may include solving the reflection tomography problem by minimizing a cost function minimization criterion in a similar manner to the approach used at block 254.

In one implementation, the cost functions for the refraction traveltime tomography at block 250 and the reflection tomography at block 260 may be integrated into the following equation:

$$E ( m ) = {\sum }_{k} {\sum }_{l} {\sum }_{( i , j )} {ɛ}_{ij ( kl )} + λ {E}_{1} ( m ) \qquad Equation 12$$

where E₁ is the cost function for early-arrival traveltime tomography, such as the one expressed in Equation 4, λ denotes a weight coefficient for early-arrival traveltime misfits, and εᵢⱼ₍ₖₗ₎ denotes the mismatch between any two migrated packets for l^{th} event in k^{th} common image gather. The indices of k and l are omitted during the following derivations since the migrated packets may be assumed to correspond for the same events in a common image packet gather. By inserting Equation 11 into Equation 12, the first-order perturbation of the cost function for both the reflection tomography and refraction traveltime tomography may be obtained, and may be expressed by the following equation:

$$δ E = {\sum }_{k} {\sum }_{l} {\sum }_{( i , j )} {δɛ}_{ij} + λδ {E}_{1} = - {\sum }_{k} {\sum }_{l} {\sum }_{( i , j )} {\sum }_{x} {\sum }_{y} {\sum }_{z} {W}_{i} {W}_{j} ( {w}_{i} δ {w}_{j} + {w}_{j} δ {w}_{i} ) + λδ {E}_{1} \qquad Equation 13$$

In Equation 13, tapering function perturbations may be ignored, and wᵢ and wⱼ are time-domain source wavelets for the two migrated packets described at block 268, respectively.

If perturbations on a packet center location, a normal direction and the velocity along the normal direction are ignored, the perturbation of a source wavelet for a migrated packet may be expressed by the following equation:

$$δ {w}_{i} = δ {w}_{i} ( {τ}_{{s}_{i} {\vec{X}}_{i} {g}_{i}} - {t}_{i} + \frac{( \vec{X} - {\vec{X}}_{i} ) \cdot {\vec{n}}_{i}}{{v}_{i}} ) = {w}_{i}^{′} ( {τ}_{{s}_{i} {\vec{X}}_{i} {g}_{i}} - {t}_{i} + \frac{( \vec{X} - {\vec{X}}_{i} ) \cdot {\vec{n}}_{i}}{{v}_{i}} ) {δτ}_{{s}_{i} {\vec{X}}_{i} {g}_{i}} \qquad Equation 14$$

where w′ᵢ denotes the time derivative for the source wavelet, and δτₛ_{ᵢ}_{\vec{X}}_{ᵢ}_{g}_{ᵢ} denotes the perturbation of the total traveltime for the ray path for the packet. The total perturbation for two migrated packets may then be expressed using the following equation:

$$δ E = - {\sum }_{k} {\sum }_{l} {\sum }_{( i , j )} {\sum }_{x} {\sum }_{y} {\sum }_{z} {W}_{i} {W}_{j} ( {w}_{i} {w}_{j}^{′} {δτ}_{{s}_{j} {\vec{X}}_{j} {g}_{j}} + {w}_{j} {w}_{i}^{′} {δτ}_{{s}_{i} {\vec{X}}_{i} {g}_{i}} ) + λδ {E}_{1} = - {\sum }_{k} {\sum }_{l} {\sum }_{( i , j )} \{ {δτ}_{{s}_{j} {\vec{X}}_{j} {g}_{j}} {\sum }_{x} {\sum }_{y} {\sum }_{z} {W}_{i} {W}_{j} {w}_{i} {w}_{j}^{′} + {δτ}_{{s}_{i} {\vec{X}}_{i} {g}_{i}} {\sum }_{x} {\sum }_{y} {\sum }_{z} {W}_{i} {W}_{j} {w}_{j} {w}_{i}^{′} \} + λδ {E}_{1} \qquad Equation 15$$

where Equation 15 may provide the Frechet derivative for a conjugated gradient solver.

At block 278, it may be determined whether the updated model from block 274 has converged to a cost function minimization criterion. If the updated model has not converged to a cost function minimization criterion, the process may return to block 270 to repeat reflection tomography with the updated model or to block 264 to repeat the sorting and binning of the migrated packets for generating the common image packet gathers. If the updated model has converged to a corresponding cost function minimization criterion, the process may proceed to block 280 to generate a final model for the region of interest.

At block 280, a final model for the region of interest may be generated from the updated model from block 258 or block 278. For instance, the final model may be an anisotropy model for the region of interest. The final model may also be a prestack depth migration (PSDM) volume or PSDM gather for the region of interest.

At block 290, the final model may be used to facilitate hydrocarbon exploration or production in the region of interest.

In some implementations, a method for processing seismic data corresponding to a region of interest is provided. The method may receive the seismic data. The method may separate the received seismic data into refraction packets and reflection packets. The method may receive a model for the region of interest. The method may update a first portion of the received model using the refraction packets with refraction traveltime tomography. The method may use the updated model to facilitate hydrocarbon exploration or production.

In some implementations, the method may update a second portion of the received model using the reflection packets with reflection tomography. The method may also migrate the reflection packets into the depth domain. The received seismic data may also be from a common shot gather. The method may also decompose the received seismic data into a plurality of seismic packets, where the seismic packets may be separated into refraction packets and reflection packets. Updating the first portion of the received model may be performed iteratively. The received seismic data may include attributes such as a spatial location of a beam center, a spatial orientation of a beam, a source-receiver offset, a source-receiver azimuth, a reflection angle, a reflection azimuth, a wavelet identification, an amplitude of a seismic wave, a coherency for seismic traces, and a beam spread. One of the refraction packets may include the time dip of a seismic ray measured at a receiver. The method may also model one or more ray paths from the receiver to a source or vice versa using the time dip. The method may also model the traveltime of the ray paths from the receiver to the source or vice versa. The method may separate the received seismic data based on source to receiver traveltimes or source-receiver offsets. The refraction packets may describe information regarding a pressure wave that travels from a source to a receiver, where the path of the pressure wave is not changed by a reflection of the pressure wave at an impedance interface between the source and the receiver. The refraction packets may also describe information regarding a diving wave or a head wave. The reflection packets may describe information regarding a pressure wave that travels from a source to a receiver, and where the pressure wave is reflected from an impedance interface. The received model or the updated model may be a velocity model or an anisotropic model for the region of interest. Updating the first portion of the received model may include minimizing a cost function minimization criterion. The cost function minimization criterion may be a difference between a forward-modeled prediction and the received seismic data.

In some implementations, an information processing apparatus for use in a computing system is provided, and includes means for receiving seismic data corresponding to a region of interest. The information processing apparatus may also have means for separating the received seismic data into refraction packets and reflection packets. The information processing apparatus may also have means for receiving a model for the region of interest. The information processing apparatus may also have means for updating a portion of the received model using the refraction packets with refraction traveltime tomography. The information processing apparatus may also have means for using the updated model to facilitate hydrocarbon exploration or production.

In some implementations, a computing system is provided that includes at least one processor, at least one memory, and one or more programs stored in the at least one memory, wherein the programs include instructions, which when executed by the at least one processor cause the computing system to receive seismic data corresponding to a region of interest. The programs may further include instructions to cause the computing system to separate the received seismic data into refraction packets and reflection packets. The programs may further include instructions to cause the computing system to receive a model for the region of interest. The programs may further include instructions to cause the computing system to update a portion of the received model using the refraction packets with refraction traveltime tomography. The programs may further include instructions to cause the computing system to use the updated model to facilitate hydrocarbon exploration or production.

In some implementations, a computer readable storage medium is provided, which has stored therein one or more programs, the one or more programs including instructions, which when executed by a processor, cause the processor to receive seismic data corresponding to a region of interest. The programs may further include instructions, which cause the processor to separate the received seismic data into refraction packets and reflection packets. The programs may further include instructions, which cause the processor to receive a model for the region of interest. The programs may further include instructions, which cause the processor to update a portion of the received model using the refraction packets with refraction traveltime tomography. The programs may further include instructions, which cause the processor to use the updated model to facilitate hydrocarbon exploration or production.

In some implementations, a method for processing seismic data corresponding to a region of interest is provided. The method may receive the seismic data. The method may decompose the received seismic data into a plurality of seismic packets. The method may separate the seismic packets into refraction packets and reflection packets. The method may receive a model that describes the region of interest. The method may update a first portion of the received model using the refraction packets with refraction traveltime tomography. The method may update a second portion of the received model using the reflection packets with reflection tomography. The method may use an updated model based on the updated first portion and second portion of the received model to facilitate hydrocarbon exploration or production.

In some implementations, an information processing apparatus for use in a computing system is provided, and includes means for receiving seismic data corresponding to a region of interest. The information processing apparatus may also have means for decomposing the received seismic data into a plurality of seismic packets. The information processing apparatus may also have means for separating the seismic packets into refraction packets and reflection packets. The information processing apparatus may also have means for receiving a model for the region of interest. The information processing apparatus may also have means for updating a first portion of the received model using the refraction packets with refraction traveltime tomography. The information processing apparatus may also have means for updating a second portion of the received model using the reflection packets with reflection tomography. The information processing apparatus may also have means for using an updated model based on the updated first portion and second portion of the received model to facilitate hydrocarbon exploration or production.

In some implementations, a computing system is provided that includes at least one processor, at least one memory, and one or more programs stored in the at least one memory, wherein the programs include instructions, which when executed by the at least one processor cause the computing system to receive seismic data corresponding to a region of interest. The programs may further include instructions to cause the computing system to decompose the received seismic data into a plurality of seismic packets. The programs may further include instructions to cause the computing system to separate the seismic packets into refraction packets and reflection packets. The programs may further include instructions to cause the computing system to receive a model that describes the region of interest. The programs may further include instructions to cause the computing system to update a first portion of the received model using the refraction packets with refraction traveltime tomography. The programs may further include instructions to cause the computing system to update a second portion of the received model using the reflection packets with reflection tomography. The programs may further include instructions to cause the computing system to use an updated model based on the updated first portion and second portion of the received model to facilitate hydrocarbon exploration or production.

In some implementations, a computer readable storage medium is provided, which has stored therein one or more programs, the one or more programs including instructions, which when executed by a processor, cause the processor to receive seismic data corresponding to a region of interest. The programs may further include instructions, which cause the processor to decompose the received seismic data into a plurality of seismic packets. The programs may further include instructions, which cause the processor to separate the seismic packets into refraction packets and reflection packets. The programs may further include instructions, which cause the processor to receive a model that describes the region of interest. The programs may further include instructions, which cause the processor to update a first portion of the received model using the refraction packets with refraction traveltime tomography. The programs may further include instructions, which cause the processor to update a second portion of the received model using the reflection packets with reflection tomography. The programs may further include instructions, which cause the processor to use an updated model based on the updated first portion and second portion of the received model to facilitate hydrocarbon exploration or production.

In some implementations, a method for processing data corresponding to a region of interest is provided. The method may receive data corresponding to a region of interest. The method may separate the data into refraction packets and reflection packets. The method may receive a model that describes the region of interest. The method may update a first portion of the received model using the refraction packets with refraction traveltime tomography. The method may update a second portion of the received model using the reflection packets with reflection tomography.

In some implementations, an information processing apparatus for use in a computing system is provided, and includes means for receiving data corresponding to a region of interest. The information processing apparatus may also have means for separating the data into refraction packets and reflection packets. The information processing apparatus may also have means for receiving a model for the region of interest. The information processing apparatus may also have means for updating a first portion of the received model using the refraction packets with refraction traveltime tomography. The information processing apparatus may also have means for updating a second portion of the received model using the reflection packets with reflection tomography.

In some implementations, a computing system is provided that includes at least one processor, at least one memory, and one or more programs stored in the at least one memory, wherein the programs include instructions, which when executed by the at least one processor cause the computing system to receive data corresponding to a region of interest. The programs may further include instructions to cause the computing system to separate the data into refraction packets and reflection packets. The programs may further include instructions to cause the computing system to receive a model that describes the region of interest. The programs may further include instructions to cause the computing system to update a first portion of the received model using the refraction packets with refraction traveltime tomography. The programs may further include instructions to cause the computing system to update a second portion of the received model using the reflection packets with reflection tomography.

In some implementations, a computer readable storage medium is provided, which has stored therein one or more programs, the one or more programs including instructions, which when executed by a processor, cause the processor to receive data corresponding to a region of interest. The programs may further include instructions, which cause the processor to separate the data into refraction packets and reflection packets. The programs may further include instructions, which cause the processor to receive a model that describes the region of interest. The programs may further include instructions, which cause the processor to update a first portion of the received model using the refraction packets with refraction traveltime tomography. The programs may further include instructions, which cause the processor to update a second portion of the received model using the reflection packets with reflection tomography.

### Computing System

Implementations of various technologies described herein may be operational with numerous general purpose or special purpose computing system environments or configurations. Examples of well known computing systems, environments, and/or configurations that may be suitable for use with the various technologies described herein include, but are not limited to, personal computers, server computers, hand-held or laptop devices, multiprocessor systems, microprocessor-based systems, set top boxes, programmable consumer electronics, network PCs, minicomputers, mainframe computers, smartphones, smartwatches, personal wearable computing systems networked with other computing systems, tablet computers, and distributed computing environments that include any of the above systems or devices, and the like.

The various technologies described herein may be implemented in the general context of computer-executable instructions, such as program modules, being executed by a computer. Generally, program modules include routines, programs, objects, components, data structures, etc., that performs particular tasks or implement particular abstract data types. While program modules may execute on a single computing system, it should be appreciated that, in some implementations, program modules may be implemented on separate computing systems or devices adapted to communicate with one another. A program module may also be some combination of hardware and software where particular tasks performed by the program module may be done either through hardware, software, or both.

The various technologies described herein may also be implemented in distributed computing environments where tasks are performed by remote processing devices that are linked through a communications network, e.g., by hardwired links, wireless links, or combinations thereof. The distributed computing environments may span multiple continents and multiple vessels, ships or boats. In a distributed computing environment, program modules may be located in both local and remote computer storage media including memory storage devices.

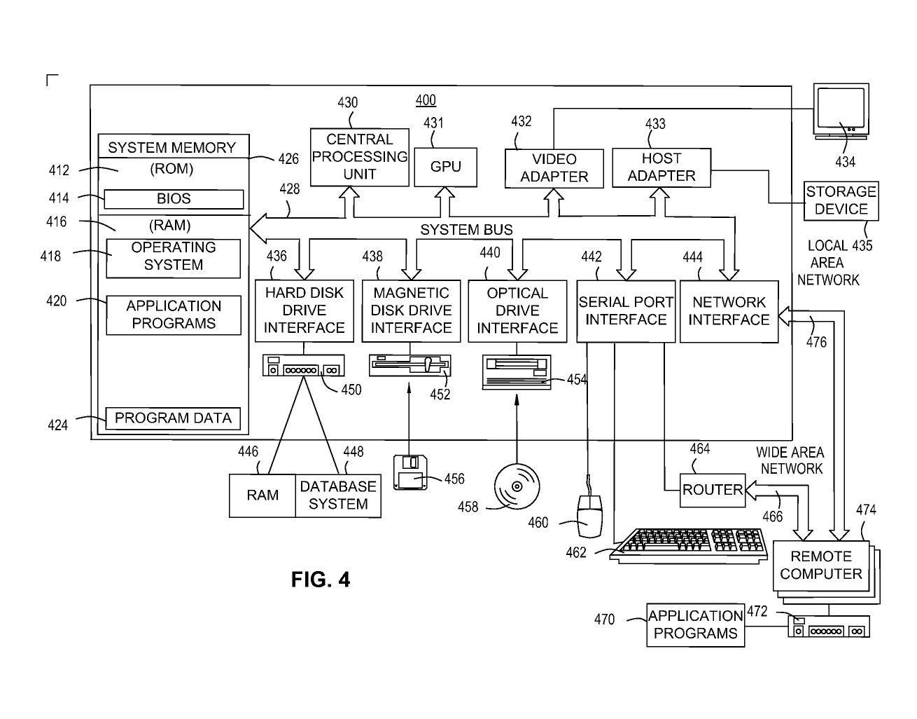

FIG. 4 illustrates a schematic diagram of a computing system 400 in which the various technologies described herein may be incorporated and practiced. Although the computing system 400 may be a conventional desktop or a server computer, as described above, other computer system configurations may be used.

The computing system 400 may include a central processing unit (CPU) 430, a system memory 426, a graphics processing unit (GPU) 431 and a system bus 428 that couples various system components including the system memory 426 to the CPU 430. Although one CPU is illustrated in FIG. 4, it should be understood that in some implementations the computing system 400 may include more than one CPU. The GPU 431 may be a microprocessor specifically designed to manipulate and implement computer graphics. The CPU 430 may offload work to the GPU 431. The GPU 431 may have its own graphics memory, and/or may have access to a portion of the system memory 426. As with the CPU 430, the GPU 431 may include one or more processing units, and the processing units may include one or more cores. The system bus 428 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. The system memory 426 may include a read-only memory (ROM) 412 and a random access memory (RAM) 416. A basic input/output system (BIOS) 414, containing the basic routines that help transfer information between elements within the computing system 400, such as during start-up, may be stored in the ROM 412.

The computing system 400 may further include a hard disk drive 450 for reading from and writing to a hard disk, a magnetic disk drive 452 for reading from and writing to a removable magnetic disk 456, and an optical disk drive 454 for reading from and writing to a removable optical disk 458, such as a CD ROM or other optical media. The hard disk drive 450, the magnetic disk drive 452 and the optical disk drive 454 may be connected to the system bus 428 by a hard disk drive interface 436, a magnetic disk drive interface 438 and an optical drive interface 440, respectively. The drives and their associated computer-readable media may provide nonvolatile storage of computer-readable instructions, data structures, program modules and other data for the computing system 400.

Although the computing system 400 is described herein as having a hard disk, a removable magnetic disk 456 and a removable optical disk 458, it should be appreciated by those skilled in the art that the computing system 400 may also include other types of computer-readable media that may be accessed by a computer. For example, such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computing system 400. Communication media may embody computer readable instructions, data structures, program modules or other data in a modulated data signal, such as a carrier wave or other transport mechanism and may include any information delivery media. The term “modulated data signal” may mean a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. The computing system 400 may also include a host adapter 433 that connects to a storage device 435 via a small computer system interface (SCSI) bus, a Fiber Channel bus, an eSATA bus or using any other applicable computer bus interface. Combinations of any of the above may also be included within the scope of computer readable media.

A number of program modules may be stored on the hard disk 450, magnetic disk 456, optical disk 458, ROM 412 or RAM 416, including an operating system 418, one or more application programs 420, program data 424 and a database system 448. The application programs 420 may include various mobile applications (“apps”) and other applications configured to perform various methods and techniques described herein. The operating system 418 may be any suitable operating system that may control the operation of a networked personal or server computer, such as Windows® XP, Mac OS® X, Unix-variants (e.g., Linux® and BSD®), and the like.

A user may enter commands and information into the computing system 400 through input devices such as a keyboard 462 and pointing device 460. Other input devices may include a microphone, joystick, game pad, satellite dish, scanner or the like. These and other input devices may be connected to the CPU 430 through a serial port interface 442 coupled to system bus 428, but may be connected by other interfaces, such as a parallel port, game port or a universal serial bus (USB). A monitor 434 or other type of display device may also be connected to system bus 428 via an interface, such as a video adapter 432. In addition to the monitor 434, the computing system 400 may further include other peripheral output devices such as speakers and printers.

Further, the computing system 400 may operate in a networked environment using logical connections to one or more remote computers 474. The logical connections may be any connection that is commonplace in offices, enterprise-wide computer networks, intranets, and the Internet, such as local area network (LAN) 476 and a wide area network (WAN) 466. The remote computers 474 may be another a computer, a server computer, a router, a network PC, a peer device or other common network node, and may include many of the elements describes above relative to the computing system 400. The remote computers 474 may also each include application programs 470 similar to that of the computer action function.

When using a LAN networking environment, the computing system 400 may be connected to the local network 476 through a network interface or adapter 444. When used in a WAN networking environment, the computing system 400 may include a router 464, wireless router or other means for establishing communication over a wide area network 466, such as the Internet. The router 464, which may be internal or external, may be connected to the system bus 428 via the serial port interface 442. In a networked environment, program modules depicted relative to the computing system 400, or portions thereof, may be stored in a remote memory storage device 435. It will be appreciated that the network connections shown are merely examples and other means of establishing a communications link between the computers may be used.

The network interface 444 may also utilize remote access technologies (e.g., Remote Access Service (RAS), Virtual Private Networking (VPN), Secure Socket Layer (SSL), Layer 2 Tunneling (L2T), or any other suitable protocol). These remote access technologies may be implemented in connection with the remote computers 474.

It should be understood that the various technologies described herein may be implemented in connection with hardware, software or a combination of both. Thus, various technologies, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the various technologies. In the case of program code execution on programmable computers, the computing device may include a processor, a storage medium readable by the processor (including volatile and non-volatile memory and/or storage elements), at least one input device and at least one output device. One or more programs that may implement or utilize the various technologies described herein may use an application programming interface (API), reusable controls and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations. Also, the program code may execute entirely on a user's computing device, partly on the user's computing device, as a stand-alone software package, partly on the user's computer and partly on a remote computer or entirely on the remote computer or a server computer.

Those with skill in the art will appreciate that any of the listed architectures, features or standards discussed above with respect to the example computing system 400 may be omitted for use with a computing system used in accordance with the various embodiments disclosed herein because technology and standards continue to evolve over time.

Of course, many processing techniques for collected data, including one or more of the techniques and methods disclosed herein, may also be used successfully with collected data types other than seismic data. While certain implementations have been disclosed in the context of seismic data collection and processing, those with skill in the art will recognize that one or more of the methods, techniques, and computing systems disclosed herein can be applied in many fields and contexts where data involving structures arrayed in a three-dimensional space and/or subsurface region of interest may be collected and processed, e.g., medical imaging techniques such as tomography, ultrasound, MRI and the like for human tissue; radar, sonar, and LIDAR imaging techniques; and other appropriate three-dimensional imaging problems.

Although the subject matter has been described in language specific to structural features and/or methodological acts, it is to be understood that the subject matter defined in the appended claims is not limited to the specific features or acts described above. Rather, the specific features and acts described above are disclosed as example forms of implementing the claims.

While the foregoing is directed to implementations of various technologies described herein, other and further implementations may be devised without departing from the basic scope thereof, which may be determined by the claims that follow. Although the subject matter has been described in language specific to structural features and/or methodological acts, it is to be understood that the subject matter defined in the appended claims is not limited to the specific features or acts described above. Rather, the specific features and acts described above are disclosed as example forms of implementing the claims.

What is claimed is:

1. A method for processing seismic data corresponding to a region of interest, comprising:
receiving the seismic data;
decomposing the received seismic data into a plurality of seismic packets;
receiving a model for the region of interest;
updating a first portion of the received model using the plurality of seismic packets with refraction traveltime tomography; and
using the updated model to facilitate hydrocarbon exploration or production.

2. The method of claim 1, further comprising updating a second portion of the received model using the plurality of seismic packets with reflection tomography.

3. The method of claim 1, wherein the received seismic data is from a common shot gather.

4. The method of claim 1, wherein the plurality of seismic packets comprises refraction packets and reflection packets.

5. The method of claim 1, wherein updating the first portion of the received model is performed iteratively.

6. The method of claim 1, wherein the received seismic data includes one or more attributes selected from the group consisting of:
a spatial location of a beam center;
a spatial orientation of a beam;
a source-receiver offset;
a source-receiver azimuth;
a reflection angle;
a reflection azimuth;
a wavelet identification;
an amplitude of a seismic wave;
a coherency for seismic traces; and
a beam spread.

7. The method of claim 1, wherein updating the first portion of the received model comprises modeling one or more ray paths from a receiver to a source or vice versa using the time dip of a seismic ray measured at the receiver.

8. The method of claim 7, wherein modeling the ray paths comprises modeling the traveltime of the ray paths from the receiver to the source or vice versa.

9. The method of claim 1, wherein the received model or the updated model is a velocity model or an anisotropic model for the region of interest.

10. The method of claim 1, wherein updating the first portion of the received model comprises minimizing a cost function minimization criterion.

11. The method of claim 10, wherein the cost function minimization criterion comprises a difference between a forward-modeled prediction and the received seismic data.

12. A non-transitory computer-readable medium having stored thereon a plurality of computer-executable instructions which, when executed by a computer, cause the computer to:
receive the seismic data;
decompose the received seismic data into a plurality of seismic packets;
receive a model that describes the region of interest;
update a first portion of the received model using the plurality of seismic packets with refraction traveltime tomography;
update a second portion of the received model using the plurality of seismic packets with reflection tomography; and
use an updated model based on the updated first portion and second portion of the received model to facilitate hydrocarbon exploration or production.

13. The non-transitory computer-readable medium of claim 12, wherein the plurality of seismic packets comprises refraction packets and reflection packets.

14. The non-transitory computer-readable medium of claim 12, wherein the computer-executable instructions which, when executed by a computer, cause the computer to update the first portion of the received model, further comprise computer-executable instructions which, when executed by the computer, cause the computer to model one or more ray paths from a receiver to a source or vice versa using the time dip of a seismic ray measured at the receiver.

15. The non-transitory computer-readable medium of claim 14, wherein the computer-executable instructions which, when executed by a computer, cause the computer to model the ray paths, further comprise computer-executable instructions which, when executed by the computer, cause the computer to model the traveltime of the ray paths from the receiver to the source or vice versa.

16. The non-transitory computer-readable medium of claim 12, wherein the received model or the updated model is a velocity model or an anisotropic model for the region of interest.

17. The non-transitory computer-readable medium of claim 12, wherein the computer-executable instructions which, when executed by a computer, cause the computer to update the first portion of the received model, further comprise computer-executable instructions which, when executed by the computer, cause the computer to minimize a cost function minimization criterion.

18. The non-transitory computer-readable medium of claim 17, wherein the cost function minimization criterion comprises a difference between a forward-modeled prediction and the received seismic data.

19. A method, comprising:
receiving seismic data corresponding to a region of interest;
decomposing the received seismic data into a plurality of seismic packets;
receiving a model that describes the region of interest;
updating a first portion of the received model using the plurality of seismic packets with refraction traveltime tomography; and
updating a second portion of the received model using the plurality of seismic packets with reflection tomography.

20. The method of claim 19, wherein the received seismic data is from a common shot gather.
